(19) United States
(12) Patent Application Publication
(10) Pub. No.: US 2022/0134515 A1
(43) Pub. Date: May 5, 2022

(54) ADJUSTABLE LOCKING PLIERS AND LOCK ASSEMBLY

(71) Applicant: ARMOR TOOL LLC, PHOENIX, AZ (US)

(72) Inventors: DAN POOL, Scottsdale, AZ (US); JEFF MOWRY, Westcliffe, CO (US); DANIEL L. POOLE, Glendale, AZ (US)

(73) Assignee: ARMOR TOOL LLC, PHOENIX, AZ (US)

(21) Appl. No.: 17/514,226

(22) Filed: Oct. 29, 2021

Related U.S. Application Data
(60) Provisional application No. 63/108,326, filed on Oct. 31, 2020.

(51) Int. Cl. B25B 7/14; B25B 7/10

(52) U.S. Cl. CPC B25B 7/14; B25B 7/10

(57) ABSTRACT

Adjustable locking pliers includes a lock assembly, a jaw pressure adjustment wheel for adjusting the clamping pressure and a cam plate.

### CROSS-REFERENCE TO RELATED APPLICATION

The present application claims the benefit of U.S. Provisional Application No. 63/108,326 filed Oct. 31, 2020, the entirety of which is hereby incorporated by reference.

### FIELD OF USE

This present invention relates generally to adjustable locking pliers and lock assembly. Specifically, the invention relates to adjustable locking pliers and lock assembly that provide more reliable self-locking.

### BACKGROUND

Conventional adjustable locking pliers and clamps have been available for years, but can be difficult to adjust. For instance, setting clamping pressure can be difficult. With conventional adjustable locking pliers, adjusting the jaw pressure is generally accomplished using a screw. The screw tends to loosen and change position after clamping. To prevent this, springs or nuts have been employed to help prevent the adjustment screw from unintentionally rotating. However, the spring often limits the degree of available adjustability, sometimes making low-pressure adjustments difficult. Nuts require wrenches of specific sizes to secure and tighten properly, and the available space surrounding the adjustment screw is often small, making it difficult to use. Also, many conventional locking mechanisms place most of the adjustability in a narrow area so that a lot of the adjustable area is outside of useful range.

Further, the movable handle of adjustable locking pliers often will open beyond a useful range, pulling the movable handle too far making it difficult to grip with one hand.

Traditional methods of manufacturing the mechanical lock assembly of adjustable locking pliers and clamps are quite difficult, and require special alloys and difficult processes such as precision lost wax casting or metal injection molding with secondary broaching and clean-up procedures that make it difficult to achieve required tolerances. Variation in manufacturing tolerances can cause problems in achieving uniform pressure from one set of pliers to another, sometimes producing unusable areas of pressure such as requiring too much pressure to close the pliers or too little pressure to grip anything effectively. Also, slight variations in manufacturing tolerances can create large in how each lock assembly performs. This drawbacks can result in frustration among users and costly returns.

### SUMMARY

There is a need for improved adjustable locking pliers and clamps that include improved jaw pressure adjustment mechanisms, improved lock assembly mechanism and an improved movable handle reach.

Adjustable locking pliers (10) comprising a lower handle (18) and upper handle (17) for opening and closing an upper jaw (8) and a lower jaw (9), a lock assembly (12) comprising a lock (20) and a pivoting arm (19), a cam plate (21) rotatably connected to the lock (20) and the pivoting arm (19) and a rotatable jaw pressure adjustment wheel (11) mounted to the pivoting arm (19) for adjusting a gap between a contact portion (35) of the cam plate (21) and the pivoting arm (19).

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIGS. 1A and 1B show a cutaway side view of an embodiment of the adjustable locking pliers in an open position and closed position, respectively.

FIGS. 2A and 2B show a side view of the lock assembly of the adjustable locking pliers of FIGS. 1A and 1B.

FIG. 3 shows further details of the jaw pressure adjustment wheel of the adjustable locking pliers of FIGS. 1A and 1B.

FIG. 4 shows a guide bar on which the lock of the lock assembly of the adjustable locking pliers of FIGS. 1A and 1B slides.

FIGS. 5A and 5B show alternative embodiments of the lock assembly comprising a jaw pressure adjustment index rod.

FIG. 6 shows an alternative embodiment of the lock assembly comprising a fixed preset jaw pressure rod.

FIG. 7 shows an alternative embodiment of the lock assembly comprising a jaw pressure adjustment bumper wheel.

FIGS. 8A and 8B show an alternative embodiment of the lock assembly.

FIGS. 9A-9C show alternative embodiments.

FIGS. 10A and 10B show an alternative embodiment of the lock assembly.

### DETAILED DESCRIPTION

The subject innovation is now described with reference to the drawings, wherein like reference numerals are used to refer to like elements throughout. In the following description, for purposes of explanation, numerals specific details are set forth in order to provide a thorough understanding of the present invention. It may be evident, however, that the present invention may be practiced without these specific details.

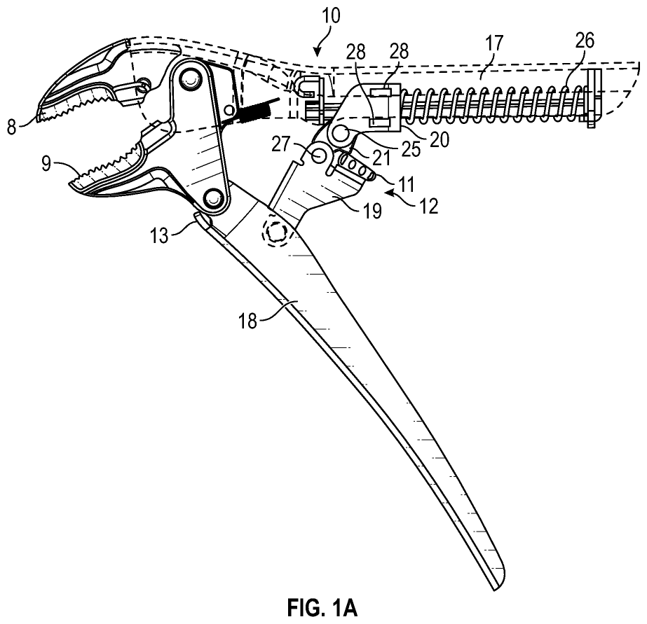

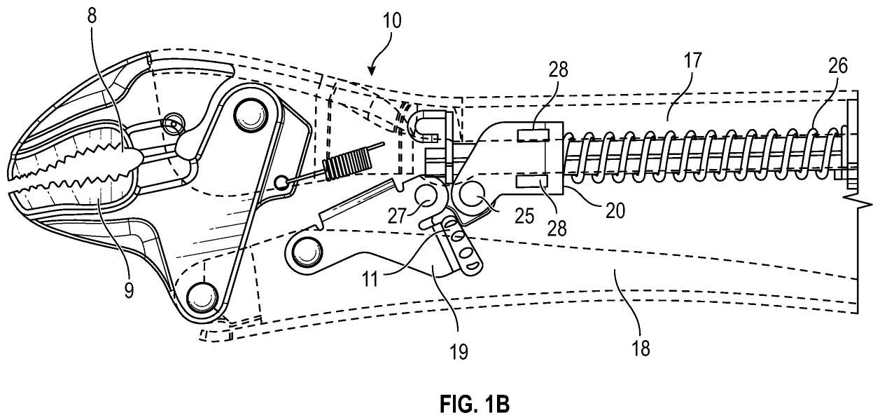

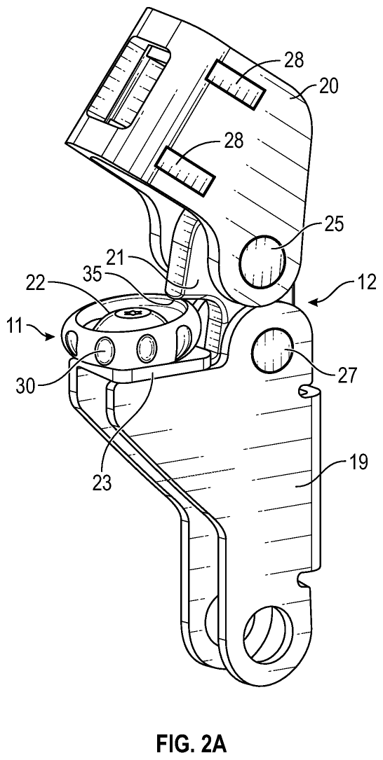

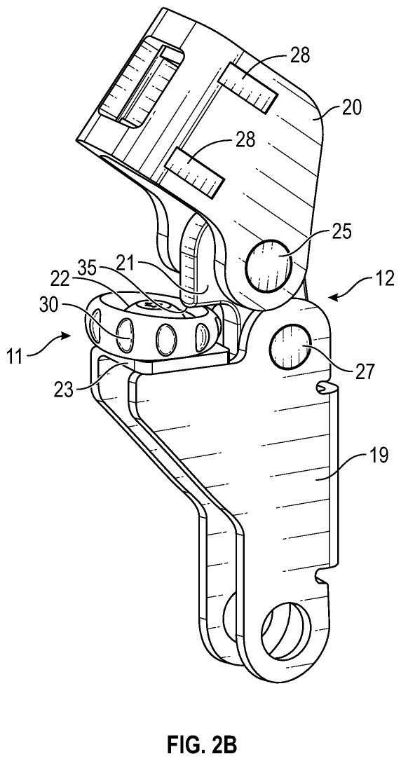

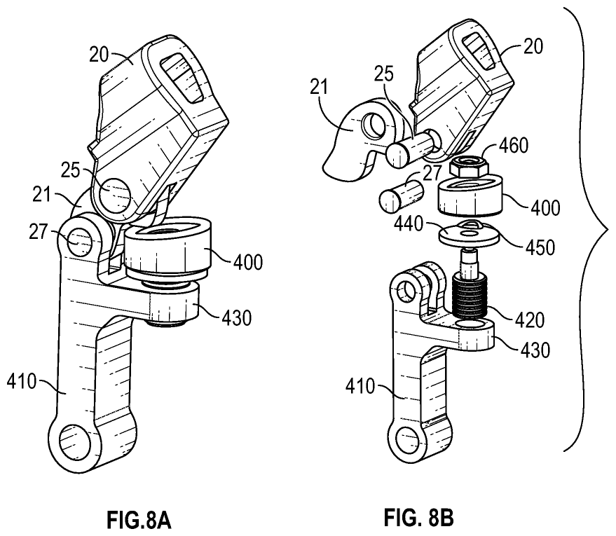

An exemplary embodiment of the present invention is shown in FIGS. 1A, 1B, 2A, 2B, 3 and 4. As shown in FIG. 1A, which shows the pliers in the open position, the adjustable locking pliers 10 comprises upper jaw 8 and lower jaw 9 that are used to clamp a workpiece (not shown) by squeezing lower handle 18 to upper handle 17, thereby clamping upper jaw 8 and lower jaw 9 to the workpiece. The pliers 10 also comprise a jaw pressure adjustment wheel 11 that is used to adjust the gap between the upper and lower jaws when the pliers are closed, thereby adjusting the pressure exerted on the workpiece by the upper and lower jaws. The jaw pressure adjustment wheel 11 can rotate 360 degrees in either direction to tighten or loosen the jaw pressure adjustment wheel 11. As shown in FIG. 1A, the jaw pressure adjustment wheel 11 is contained in a lock assembly 12 that is rotatably secured to the upper and lower handles. The lock assembly 12 comprises a lock 20 and a pivoting arm 19 that are rotatably secured to the upper and lower handles, respectively. As shown in FIGS. 2A and 2B, a contact portion 35 at a front portion of a cam plate 21 that is rotatably secured to the lock 20 through lock pin 25 and rotatably secured to the pivoting arm 19 through cam pin 27 abuts the jaw pressure adjustment wheel 11 to thereby control the gap between the contact portion 35 of the cam plate 21 and the pivoting arm 19, thereby adjusting the pressure exerted on the workpiece by the upper and lower jaws when the pliers are closed. The lower handle 18 can include a movable handle stop 13 that can limit the motion of the lower handle 18 in order to maintain the position of the lower handle 18 is a useful range so that the pliers can be gripped with one hand. This embodiment, and all embodiments described herein, also can be used with an L-shaped pivoting arm, as presented below in the description of FIGS. 8A and 8B.

FIG. 1B shows the pliers of FIG. 1A in the closed position. As shown in FIG. 1B, even in the closed position, the jaw pressure adjustment wheel 11 is accessible to the user so that it can be rotated while the pliers are in the closed position.

The lock assembly 12 can be made using any appropriate manufacturing method such as injection molding (e.g., metal injection molding), cast with lost wax method or investment casting and broached to precise tolerances. Alternatively, stamped metal parts can be used for the lock assembly 12. Using sheet metal can reduce the complexity in the geometry used in the lock assembly, reduce material use and improve the manufacturing specifications of the lock assembly, thereby reducing manufacturing costs and providing consistent product reliability while reducing costs. When using sheet metal, hardened inserts 28 can be used in composite with sheet metal for high precision placement of hardened locking elements with little or no secondary manufacturing operations required, thereby reducing costs. Composite sheet metal or other similar metal can be used.

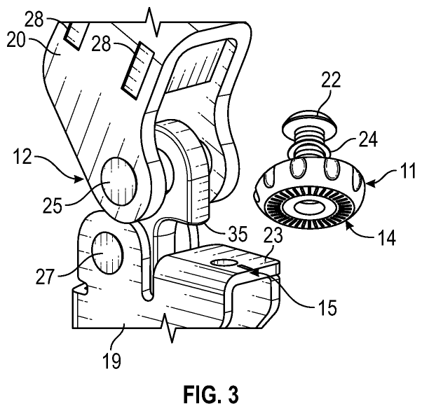

As shown in FIG. 2A, FIGS. 2B and 3, the jaw pressure adjustment wheel 11 can be secured to a top face 23 of the pivoting arm 19 with a set screw 22 that is threadedly secured the pivoting arm 19. A wave spring 24 can be used to help secure the set screw 22 to the pivoting arm 19.

As shown in FIGS. 2A and 2B, the jaw pressure adjustment wheel 11 can be wedge-shaped and can have a generally toroidal cross section. A top surface of the jaw pressure adjustment wheel 11 can form an analog inclined plane so that the height of the jaw pressure adjustment wheel changes along the circumference of the jaw pressure adjustment wheel. When the jaw pressure adjustment wheel 11 is rotated, the adjustment gap between the contact portion 35 of the cam plate 21 and the pivoting arm 19 smoothly transitions from a large adjustment gap to a smaller adjustment gap to vary the pressure exerted on the workpiece by the upper jaw 8 and lower jaw 9. Specifically, a larger adjustment gap, as shown in FIG. 2A, creates a smaller pressure. A smaller adjustment gap, as shown in FIG. 2B, creates a larger pressure. The range of motion between the minimum and maximum pressure setting can be quite small, often as little as ⅛″.

The toroidal cross section of the jaw pressure adjustment wheel 11 creates a single point of contact between the cam plate 21 and the jaw pressure adjustment wheel 11 of the pivoting arm 19. The dimensions and shape of the jaw pressure adjustment wheel 11 can be set to avoid any non-useful ranges of adjustment that would prevent the pliers from locking or from locking with too little pressure. Also, if a user accidentally selects a setting that creates too much pressure, the user can rotate the jaw pressure adjustment wheel 11 slightly. The inclined plane shape of the jaw pressure adjustment wheel 11 allows for a continuum of possible pressure adjustments. The jaw pressure adjustment wheel 11 can rotate 360 degrees in either direction to adjust the pressure exerted by the upper and lower jaws, thereby creating a continuous range of pressures. Alternatively, the rotational range of the jaw pressure adjustment wheel 11 can be limited. The jaw pressure adjustment wheel 11 can include notches or indentations 30 that facilitate rotation of the jaw pressure adjustment wheel 11 by the user. This makes it possible to adjust the pressure without using tools.

As shown in FIG. 3, the bottom face of the jaw pressure adjustment wheel 11 can comprise interlocking notches 14 in the bottom thereof that interlock with notch 15 formed in the top face 23 of the pivoting arm 19. These notches can provide indication to the user of the movement of the jaw pressure adjustment wheel 11 and reduce the accidental movement of the jaw pressure adjustment wheel 11. The notches 15 can be produced in a number of ways, including spring-loaded balls, depressions, molded features, and stamped-in, as well understood by one skilled in the art. Also, elastomeric o-rings or wave springs can be used to provide pressure on the jaw pressure adjustment wheel 11 to prevent accidental movement of the jaw pressure adjustment wheel 11.

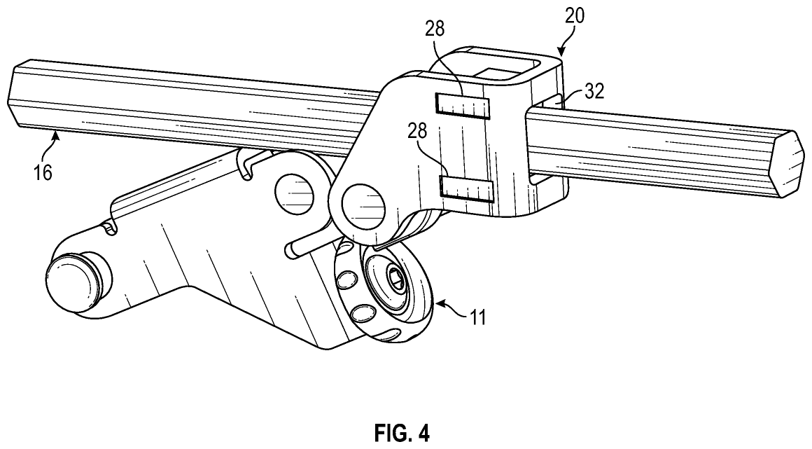

As shown in FIG. 4, the lock 20 includes a cavity 32 that can slide along guide bar 16 as the pliers are opened and closed. The cam plate 21 bears against the guide bar 16 and cants the lock 20 into frictional engagement against the guide bar 16 to create a locked position. The guide bar 16 can have any cross-sectional shape, such as trapezoidal, hexagonal, circular, square, rectangular, octagonal, etc. A hexagonal cross-sectional shape can be used because it is readily available. A spring 26 can be mounted to the guide bar 16 to bias the lock 20 towards the upper jaw 8 and lower jaw 9. Hardened inserts 28 can be used to hold the lock at a fixed position on the guide bar 16. The hardened inserts can be held in place by brazing, welding or an adhesive. When the pliers are closed, the hardened inserts 28 “bite” into the guide bar 16 so that the guide bar 16 is trapped within the lock 20, as shown in FIG. 4. Since the hardened inserts 28 only have a slight gap between the guide bar 16 and the hardened inserts 28, everything can be held in place by the various components such as the upper handle 17 and lower handle 18, as shown in FIG. 1B. The lock 20 can slide over the guide bar 16 until pressure from the cam plate 21 induces enough canting pressure upon the lock 20 to dig into the guide bar 16. By rotating the jaw pressure adjustment wheel 11, the user can adjust the clamping pressure on the workpiece, from relatively low pressure to high pressure. Accordingly, the pliers can be used to set a pressure that automatically adapts to any size object that the pliers can grasp.

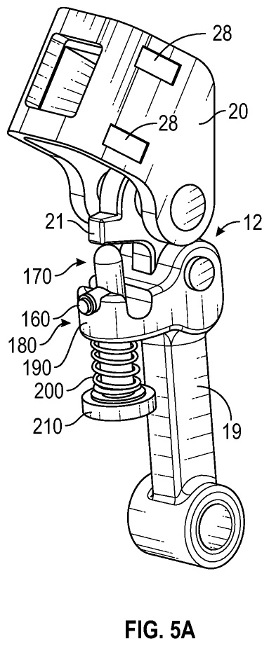

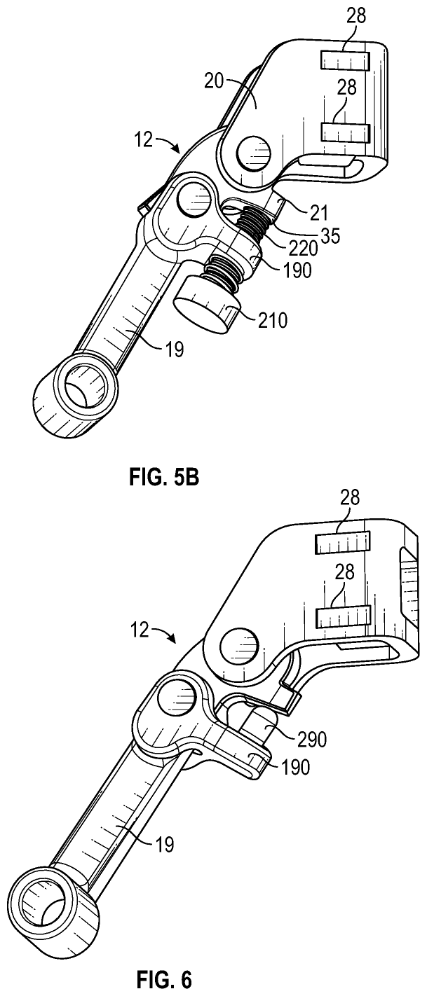

An alternative embodiment of the lock assembly is shown in FIG. 5A. As shown in FIG. 5A, this embodiment comprises a jaw pressure adjustment index rod 170 that can provide a plurality of pressure settings, for example low, medium and high pressures, that can be used for different applications. For example, the low setting could be used for soft or delicate wood, the medium setting could be used for holding a work item for use with other tools, and the high setting could be used for vigorously holding an object that might tend to be detached. The jaw pressure adjustment index rod 170 comprises a peg 160 that can fit into a plurality of index cradles 180 formed in support 190 formed in pivoting arm 19, as shown in FIG. 5A. The jaw pressure adjustment index rod 170 works together with the index cradles 180 to provide the plurality of pressure settings. Each of the plurality of index cradles 180 has a specific depth that can be selected to create the plurality of specific pressure settings against the cam plate 21. The plurality of pressure settings can encompass a depth range of approximately ⅛ inch. Since the pressure setting are preset, the entire useful depth range can be utilized. The pressure is adjusted by manually pushing the jaw pressure adjustment index rod 170 against the bias of the spring 200 and manually twisting the jaw pressure adjustment index rod 170 so that the peg 160 aligns with one of the plurality of index cradles 180. A spring 200 can be used to hold the peg 160 in one of the plurality of index cradles 180 by biasing the jaw pressure adjustment index rod 170 away from the lock 20. This helps prevent accidental pressure adjustments caused by vibrations or inadvertent touching by the user. A grooved cap 210 can be used to assist in twisting the jaw pressure adjustment index rod 170 in order to align the peg 160 with the desired index cradle 180. FIG. 5B shows another embodiment of the lock assembly that is similar to the embodiment shown in FIG. 5A. The lock assembly of FIG. 5B includes an index rod 220 that does not comprise a peg as in FIG. 5A. The index rod (220) is threadedly attached to the support 190. The position of the index rod 220 relative to the support 190 can be adjusted by manually rotating the grooved cap 210, thereby adjusting the gap between a contact portion of the cam plate 21 and the support 190 to vary the pressure exerted on the workpiece by the upper jaw 8 and lower jaw 9.

Another embodiment of the lock assembly is shown in FIG. 6 includes a fixed preset jaw pressure rod 290 that can provide a factory preset pressure to the jaws 8 and 9. The fixed preset jaw pressure rod 290 is fixed to a support (190) formed in the pivoting arm 19. With this embodiment, the user does not need to make any adjustments. Instead, a range of pliers or clamps with preset pressures can be made available for dedicated use for a variety of desired pressures/uses, such as a low pressure setting for soft or delicate wood, a medium pressure setting for holding a work item for use with other tools, and a high pressure setting for vigorously holding an object that might tend to be detached, as presented above.

The fixed preset jaw pressure rod 290 works together with the lock assembly 12 to provide the factory preset distance between the cam plate 21 and the pivoting arm 19. This can be useful to professionals who use their tools extensively and prefer to make minimal adjustments in their tools. Using this embodiment, a professional could have a set of pliers, each with a different preset pressures for different uses. The pliers with the range of preset pressures could be color coded according to the value of the preset pressures.

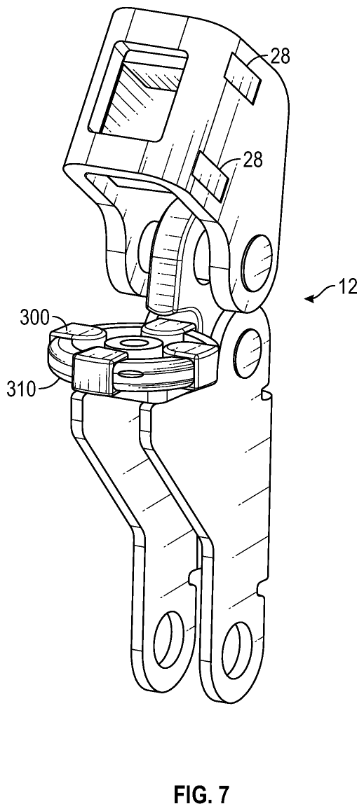

Another embodiment of the lock assembly is shown in FIG. 7. In this embodiment, elastomeric bumpers 300 are formed at various positions on a jaw pressure adjustment bumper wheel 310. The elastomeric bumpers 300 provide a plurality of pressure settings. The elastomeric bumpers 300 can provide different pressures by having different heights and/or different hardnesses. Harder materials can more firmly push the cam plate 21 into the guide bar 16 than softer materials so that it more readily causes the lock 20 to “bite” into the guide bar 16, thereby creating a given pressure that is applied to the jaws 8/9. Color coding can be used to mark the elastomeric bumpers 300 so that a user can easily select the desired pressure. Indexed springs can also be used instead of the elastomeric bumpers 300. For example, a pair of back-to-back disc springs having cam-meeting faces that have inclined planes having varied tilt angles can be used to create a force-based pressure adjustment. The various pressures can be selected by rotating the jaw pressure adjustment bumper wheel 310 to select the desired spring and jaw pressure. Also, disc springs, such as Belleville, wave, finger curved, etc., could be used singly or stacked to dial in a pressure that would push the cam inside the guidebar 16 in a similar fashion an elastomeric material.

Another embodiment of the present invention shown in FIGS. 8A and 8B includes an L-shaped pivoting arm 410. This embodiment is similar to the embodiment shown in FIGS. 2A and 2B, includes some of the same components and operates in a similar way. As shown in FIGS. 8A and 8B, a jaw pressure adjustment wheel 400 is mounted to the L-shaped pivoting arm 410, which is rotatably secured to the cam plate 21 and lock 20 with cam pin 27 and lock pin 25. A set screw 420 is threaded into an extension arm 430 of the pivoting arm 410 for holding the jaw pressure adjustment wheel 400. Specifically, in this embodiment, the jaw pressure adjustment wheel 400 is mounted on the set screw 420 along with a wheel washer 440, wave spring 450 and lock nut 460, as shown in FIGS. 8A and 8B. The wheel washer 440 helps prevent the jaw pressure adjustment wheel 400 from accidentally moving. The jaw pressure adjustment wheel 400 is mounted to a top portion of the set screw 420. The length and/or position of the set screw 420 can be selected to set the vertical position (i.e., the direction parallel to the long arm of the L-shaped pivoting arm 410) of the jaw pressure adjustment wheel 400, thereby controlling the range of pressure created by the jaw pressure adjustment wheel 400. This preset position of the set screw 420 can be set by adjusting the amount the set screw 420 is set into the extension arm 430 during manufacture. In FIGS. 8A and 8B, the lock 20 is shown with a trapezoidal cavity for receiving the guide bar 16. As mentioned above, the guide bar 16 and associated cavity can have any cross-sectional shape, such as trapezoidal, hexagonal, circular, square, rectangular, octagonal, etc.

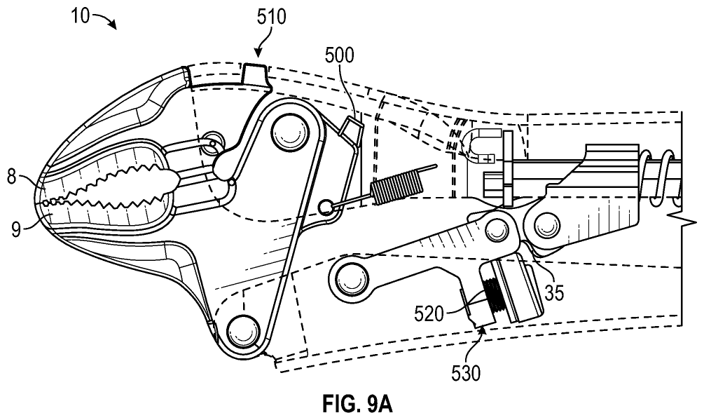

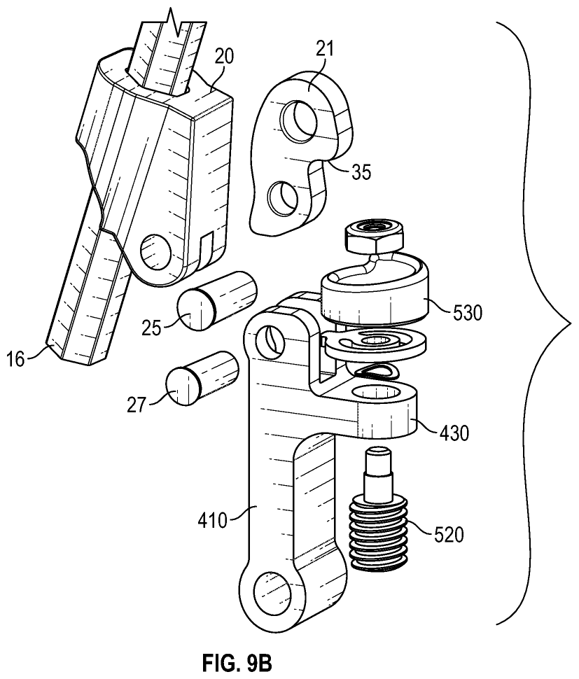

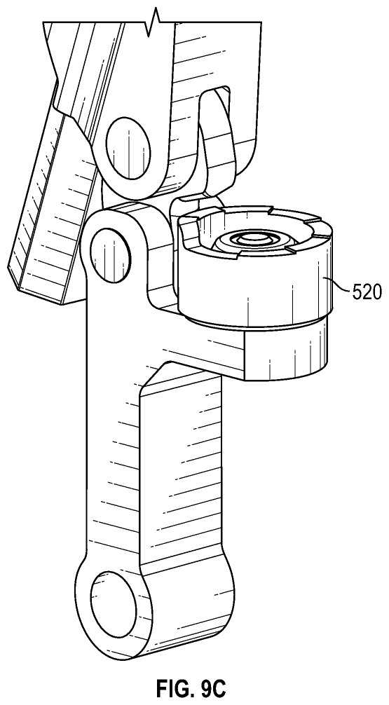

Another embodiment of the present invention shown in FIGS. 9A and 9B includes a jaw opening lobe 500, a jaw alignment tooth 510, jaw pressure adjustment wheel 520, and set screw 530. The jaw opening lobe 500 acts as a stop when the jaws are opened to the maximum open position, thereby preventing over-opening. The alignment tooth 510 keeps the jaws 8/9 aligned to the desired specifications during the assembly of the pliers. The jaw opening lobe 500 runs into the inside of the upper handle 17 when opened too far, thereby preventing the jaw from opening any further. The jaw alignment tooth 510 is formed in a top portion of the upper jaw 8, as shown in FIG. 9A, and fits into a matched form-fitting hole in an upper grip of the upper handle 17. The jaw alignment tooth 510 can be formed in the upper jaw 8, as shown by the thick solid line in FIG. 9A. When the upper jaw 8 and upper grip are passed through the braising furnace, this tooth/hole match keeps the grip and jaw 8 aligned to prevent inconsistent jaw placements. The height of the jaw pressure adjustment wheel 520 gradually increases around a circumference of the jaw pressure adjustment wheel 520 until a sharp drop-off, as shown in FIG. 9B, thereby creating the continuous range of gaps which creates the continuous range of pressures in a similar fashion as the jaw pressure adjustment wheel 11 shown in FIGS. 2A and 2B.

Another embodiment of the present invention is shown in FIG. 9C. As shown therein, jaw pressure adjustment wheel 520 can be indexed or stepped. The steps have different heights thereby creating different gaps between the pivoting arm and the contact portion of the cam plate, thereby creating different jaw pressures.

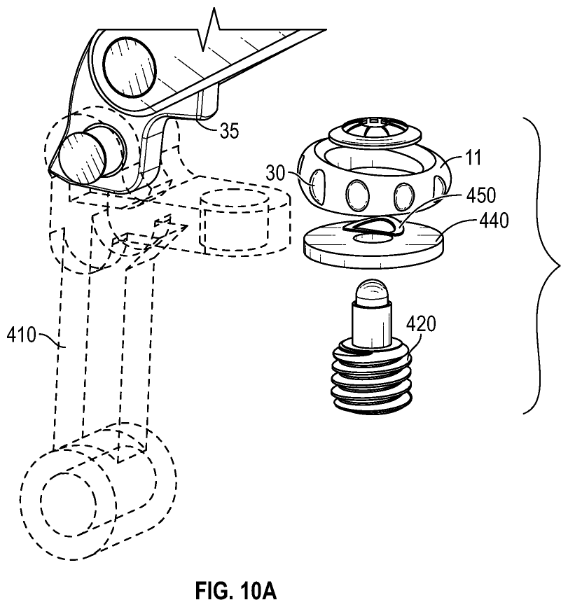

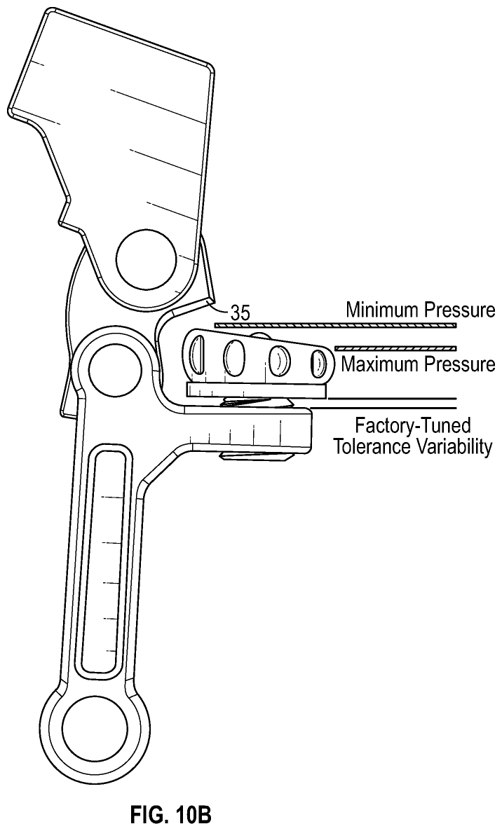

Another embodiment of the present invention is shown in FIGS. 10A and 10B. This embodiment is similar to the embodiment shown in FIGS. 8A and 8B, and includes the jaw pressure adjustment wheel 11 of FIGS. 1, 2A, 2B, 3 and 4. Instead of having the jaw pressure adjustment wheel 11 positioned on the top face 23 of the pivoting arm 19, as shown in FIG. 3, the jaw pressure adjustment wheel 11 can be positioned on the circular wheel washer 440, as shown in FIG. 10A. As mentioned above with respect to FIGS. 8A and 8B, the length and/or position of the set screw 420 can be selected and set to a pre-set specification at the factory to set the vertical position (i.e., the direction parallel to the long arm of the L-shaped pivoting arm 410) of the jaw pressure adjustment wheel 400, thereby controlling the pressure range created by the jaw pressure adjustment wheel 400. This feature, which is illustrated in FIG. 10B, allows for the removal of dead/useless spots that can be caused by tolerance issues. The set screw 420 can be sealed with a permanent thread locker at the factory and then screwed in a little more or a little less until the maximum pressure is measured, so that the jaw pressure adjustment wheel 11 will work for the life of the pliers. Vibration or chatter will not change the pre-set pressure range or allow the set screw to loosen.

All of the lock assemblies describe herein can be used in the adjustable pliers. Also, the lock assembly described herein can be implemented in any type of tool, self-adjusting locking tool, surgical tool and in any type of locking mechanisms, such as auto-locking pliers, auto-locking clamps, etc.

It should be understood that the invention is not limited by the specific embodiments described herein, which are offered by way of example and not by way of limitation. Variations and modifications of the above-described embodiments and its various aspects will be apparent to one skilled in the art and fall within the scope of the invention, as set forth in the following claims. For example, various materials, dimensions, fasteners, and connections could be used in the stairway and platform system without departing from the scope of the invention.

What is claimed is:

1. Adjustable locking pliers comprising:
lower handle and upper handle for opening and closing an upper jaw and a lower jaw;
a lock assembly comprising a lock and a pivoting arm;
a cam plate rotatably connected to the lock and the pivoting arm; and
a rotatable jaw pressure adjustment wheel mounted to the pivoting arm for adjusting a gap between a contact portion of the cam plate and the pivoting arm.

2. The adjustable locking pliers of claim 1, wherein the jaw pressure adjustment wheel is wedge-shaped and a top surface of the wedge-shaped jaw pressure adjustment wheel forms an analog inclined plane such that the height of the jaw pressure adjustment wheel changes along the circumference of the jaw pressure adjustment wheel.

3. The adjustable locking pliers of claim 2, wherein the wedge-shaped jaw pressure wheel is generally toroidal.

4. The adjustable locking pliers of claim 2, wherein the wedge-shaped jaw pressure wheel includes indentations that facilitate rotation of the jaw pressure adjustment wheel.

5. The adjustable locking pliers of claim 1, further comprising a set screw that secures the jaw pressure adjustment wheel to a top face of the pivoting arm.

6. The adjustable locking pliers of claim 5, wherein the set screw is adjustably secured to the pivoting arm so that position of the jaw pressure adjustment wheel can be adjusted.

7. The adjustable locking pliers of claim 5, wherein the set screw is permanently secured to the pivoting arm so that position of the jaw pressure adjustment wheel is set to a pre-set specification.

8. The adjustable locking pliers of claim 1, wherein the height of the jaw pressure adjustment wheel gradually increases around a circumference of the jaw pressure adjustment wheel, thereby creating a continuous range of gaps between the pivoting arm and the contact portion of the cam plate.

9. The adjustable locking pliers of claim 1, further comprising a movable handle stop that limits motion of the lower handle in order to maintain the position of the lower handle in a useful range so that the pliers can be gripped with one hand.

10. The adjustable locking pliers of claim 1, further comprising a jaw opening lobe that acts as a stop when the upper jaw and lower jaw are opened to a maximum open position, thereby preventing over-opening.

11. Adjustable locking pliers comprising:
lower handle and upper handle for opening and closing an upper jaw and a lower jaw;
a lock assembly comprising a lock and a pivoting arm;
a cam plate rotatably connected to the lock and the pivoting arm; and
a jaw pressure adjustment index rod comprising a peg that fits into a plurality of index cradles formed in a support formed in the pivoting arm, each of the plurality of index cradles has a predetermined depth that adjusts the height of the jaw pressure adjustment index rod, thereby creating a plurality of gaps between a contact portion of the cam plate and the support and a plurality of pressures against the cam plate when the pliers are closed.

12. Adjustable locking pliers comprising:
lower handle and upper handle for opening and closing an upper jaw and a lower jaw;
a lock assembly comprising a lock and a pivoting arm;
a cam plate rotatably connected to the lock and the pivoting arm; and
an index rod attached to a support formed on the pivoting arm that creates a distance between a contact portion of the cam plate and the support.

13. The adjustable locking pliers of claim 12, wherein the index rod is threadedly attached to the support, wherein the position of the index rod relative to the support can be adjusted by manually rotating the index rod, thereby adjusting the gap between a contact portion of the cam plate 21 and the support 190.

14. The adjustable locking pliers of claim 1, wherein the lock comprises a cavity that can slide along guide bar 16 as the pliers are opened and closed.

15. The adjustable locking pliers of claim 14, wherein the guide bar has a hexagonal cross-section.

16. The adjustable locking pliers of claim 1, wherein the rotatable jaw pressure adjustment wheel comprises elastomeric bumpers formed at various positions on a jaw pressure adjustment wheel.

17. The adjustable locking pliers of claim 1, wherein the jaw pressure adjustment wheel includes indentations that facilitate rotation of the jaw pressure adjustment wheel by a user.

18. The adjustable locking pliers of claim 1, wherein the jaw pressure adjustment wheel comprises interlocking notches in a bottom thereof that interlock with a notch formed in a top face of the pivoting arm.

19. A lock assembly comprising:
a lock;
a pivoting arm;
a cam plate rotatably connected to the lock and the pivoting arm; and
a rotatable jaw pressure adjustment wheel mounted to the pivoting arm for adjusting a gap between a contact portion of the cam plate and the pivoting arm.

20. The lock assembly of claim 19, wherein the jaw pressure adjustment wheel is wedge-shaped and a top surface of the wedge-shaped jaw pressure adjustment wheel forms an analog inclined plane such that the height of the jaw pressure adjustment wheel changes along the circumference of the jaw pressure adjustment wheel.

21. The lock assembly of claim 20, wherein the wedge-shaped jaw pressure wheel is generally toroidal.

22. The lock assembly of claim 20, wherein the wedge-shaped jaw pressure wheel includes indentations that facilitate rotation of the jaw pressure adjustment wheel.

23. The lock assembly of claim 19, further comprising a set screw that secures the jaw pressure adjustment wheel to a top face of the pivoting arm.

24. The lock assembly of claim 23, wherein the set screw is adjustably secured to the pivoting arm so that position of the jaw pressure adjustment wheel can be adjusted.

25. The lock assembly of claim 23, wherein the set screw is permanently secured to the pivoting arm so that position of the jaw pressure adjustment wheel is set to a pre-set specification.

26. The lock assembly of claim 19, wherein the height of the jaw pressure adjustment wheel gradually increases around a circumference of the jaw pressure adjustment wheel, thereby creating a continuous range of gaps between the pivoting arm and the contact portion of the cam plate.

27. A lock assembly comprising:
a lock;
a pivoting arm;
a cam plate rotatably connected to the lock and the pivoting arm; and
a jaw pressure adjustment index rod comprising a peg that fits into a plurality of index cradles formed in a support formed in the pivoting arm, each of the plurality of index cradles has a predetermined depth that adjusts the height of the jaw pressure adjustment index rod, thereby creating a plurality of gaps between a contact portion of the cam plate and the support and a plurality of pressures against the cam plate.

28. A lock assembly comprising:
a lock;
pivoting arm;
a cam plate rotatably connected to the lock and the pivoting arm; and
an index rod attached to a support formed on the pivoting arm that creates a distance between a contact portion of the cam plate and the support.

29. The adjustable locking pliers of claim 28, wherein the index rod is threadedly attached to the support, wherein the position of the index rod relative to the support can be adjusted by manually rotating the index rod, thereby adjusting the gap between the contact portion of the cam plate and the support.

30. The adjustable locking pliers of claim 1, further comprising an alignment tooth that keeps the upper jaw and lower jaw aligned to desired specifications during the assembly of the pliers.

31. The adjustable locking pliers of claim 10, wherein the jaw opening lobe is configured to run into an inside of the upper handle when opened too far, thereby preventing the upper jaw from opening beyond the maximum open position.

32. The adjustable locking pliers of claim 30, wherein the jaw alignment tooth is configured to fit into a matched hole in an upper grip of the upper handle such that when the upper jaw 8 and upper grip are passed through a braising furnace, the jaw alignment tooth and matched hole keep the grip and jaw 8 aligned.

33. The adjustable locking pliers of claim 1, wherein the jaw pressure adjustment wheel comprises a plurality of steps around a circumference of the jaw pressure adjustment wheel, the steps having different heights thereby creating different gaps between the pivoting arm and the contact portion of the cam plate.

34. The lock assembly of claim 19, wherein the jaw pressure adjustment wheel comprises a plurality of steps around a circumference of the jaw pressure adjustment wheel, the steps having different heights thereby creating different gaps between the pivoting arm and the contact portion of the cam plate.
